(19) United States
(12) Patent Application Publication
(10) Pub. No.: US 2025/0372757 A1
(43) Pub. Date: Dec. 4, 2025

(54) BATTERY MODULE INCLUDING FLOW CHANNEL PLATE

(71) Applicant: SK On Co., Ltd., Seoul (KR)

(72) Inventors: Se Hyeon KIM, Daejeon (KR); Sei Hoon CHO, Daejeon (KR); Do Yun KWAK, Daejeon (KR); Ji Min KIM, Daejeon (KR); Suk Ho SHIN, Daejeon (KR); Seok Hwan LEE, Daejeon (KR)

(21) Appl. No.: 19/082,173

(22) Filed: Mar. 18, 2025

(30) Foreign Application Priority Data
Jun. 3, 2024 (KR) 10-2024-0072504

(51) Int. Cl. H01M 10/6554; H01M 10/613; H01M 10/6556; H01M 50/211; H01M 50/271; H01M 50/503; H01M 50/507

(52) U.S. Cl. CPC H01M 10/6554; H01M 10/613; H01M 10/6556; H01M 50/211; H01M 50/271; H01M 50/503; H01M 50/507

(57) ABSTRACT

According to an embodiment of the present disclosure, provided is a battery module including: a housing having an accommodation space; a cell assembly accommodated in the accommodation space and including a plurality of battery cells; a first cooling port through which a cooling fluid flows into the accommodation space; a second cooling port, disposed to face the first cooling port in a first direction and through which the cooling fluid is discharged to the outside of the accommodation space; and a flow plate provided with a plurality of flow channels extending in the first direction to allow the cooling fluid to flow in the first direction in the accommodation space, and the flow plate is disposed on at least one side of the cell assembly based on a second direction, perpendicular to the first direction.

### CROSS-REFERENCE TO RELATED APPLICATIONS

This patent document claims the priority and benefits of Korean Patent Application No. 10-2024-0072504 filed on Jun. 3, 2024, the disclosure of which is incorporated herein by reference in its entirety.

### TECHNICAL FIELD

The present disclosure relates to a battery module including a flow channel plate.

### BACKGROUND

Secondary batteries, unlike primary batteries, are convenient in that the secondary batteries may be charged and discharged, and are thus receiving significant attention as a power source for various mobile devices and electric vehicles. Secondary batteries, unlike primary batteries, may be charged and discharged, and may be applied to various fields such as digital cameras, mobile phones, laptops, hybrid cars, electric vehicles, and energy storage systems (ESS). Secondary batteries may be lithium-ion batteries, nickel-cadmium batteries, nickel-metal hydride batteries, or nickel-hydrogen batteries.

These secondary batteries may include battery cells in which an electrode assembly formed by stacking a positive electrode plate, a negative electrode plate and a separator or by winding them in a roll shape is accommodated inside a case. A plurality of battery cells may be stacked in a predetermined direction and accommodated in a battery module or a battery pack.

Meanwhile, heat may be generated in the battery cell due to the electrochemical reaction during a charging and discharging process. When the heat is not quickly discharged, the heat may be accumulated in an internal space of a battery module or a battery pack, which may deteriorate performance or, in severe cases, may cause a fire. Accordingly, research is needed on a structure that directly and effectively cools the interior of a battery module or a battery pack through a cooling fluid.

### SUMMARY

According to an aspect of the present disclosure, heat exchange between a battery cell and a cooling fluid may be effectively performed.

According to an aspect of the present disclosure, a cooling fluid may smoothly flow in a space between a housing of a battery module and a battery cell.

The battery module of the present disclosure may be widely applied in green technology fields such as electric vehicles, battery charging stations, and solar power generation and wind power generation using batteries. In addition, the battery module of the present disclosure may be used in eco-friendly electric vehicles, hybrid vehicles, and the like, to ameliorate the effects of climate change by suppressing air pollution and greenhouse gas emissions.

A battery module of the present disclosure may include: a housing having an accommodation space; a cell assembly accommodated in the accommodation space and including a plurality of battery cells; a first cooling port through which a cooling fluid flows into the accommodation space; a second cooling port, disposed to face the first cooling port in a first direction and through which the cooling fluid is discharged to the outside of the accommodation space; and a flow plate provided with a plurality of flow channels extending in the first direction to allow the cooling fluid to flow in the first direction in the accommodation space, wherein the flow plate may be disposed on at least one side of the cell assembly based on a second direction, perpendicular to the first direction.

According to an embodiment, the housing may include a lower cover disposed below the cell assembly and an upper cover covering the cell assembly, and the flow plate may be disposed in at least one of a space between the cell assembly and the upper cover or a space between the cell assembly and the lower cover.

According to an embodiment, the flow plate may include: a first flow plate disposed in a space between the cell assembly and the upper cover; and a second flow plate disposed in a space between the cell assembly and the lower cover, and facing the first flow plate based on the second direction.

According to an embodiment, the flow plate may include: a first plate facing the housing; a second plate spaced apart from the first plate toward the cell assembly and facing the cell assembly; and a partition frame disposed between the first plate and the second plate to form the plurality of flow channels.

According to an embodiment, the plurality of battery cells may be stacked in a direction, perpendicular to both the first direction and the second direction, and the plurality of flow channels may be arranged in a direction in which the plurality of battery cells are stacked.

According to an embodiment, the battery module may further include a heat transfer member disposed between the flow plate and the cell assembly.

According to an embodiment, the heat transfer member may include a thermal adhesive for adhering the flow plate and the cell assembly to each other.

According to an embodiment, the battery module may further include a busbar assembly facing the cell assembly based on the first direction and electrically connected to the plurality of battery cells.

According to an embodiment, the busbar assembly may include a first busbar assembly disposed on one side of the cell assembly and a second busbar assembly disposed on the other side of the cell assembly, and the accommodation space may include: a first space between the first cooling port and the first busbar assembly; a second space between the first busbar assembly and the second busbar assembly, in which the cell assembly is disposed and; and a third space between the second busbar assembly and the second cooling port, and the flow plate may be disposed in the second space.

According to an embodiment, the busbar assembly may be spaced apart from the housing by a predetermined distance based on the second direction, so that the cooling fluid in the first space flows into the second space through the spacing gap.

According to an embodiment, the flow plate may extend in the first direction, and at least one side thereof may be disposed between the busbar assembly and the housing.

According to an embodiment, the busbar assembly may include a plurality of busbars electrically connected to the plurality of battery cells and a support frame supporting the busbars, at least one of the plurality of busbars may include a bus hole provided to allow the cooling fluid to pass therethrough, and the support frame may include at least one flow hole communicating with the bus hole and provided to allow the cooling fluid to pass therethrough.

According to an embodiment, the support frame may include at least one support hole formed between the plurality of busbars and provided to allow the cooling fluid to pass therethrough, and the support hole and the flow hole may be arranged alternately in a direction in which the plurality of battery cells are stacked.

According to an embodiment, wherein each of the plurality of battery cells may include a tab lead electrically connected to at least one of the plurality of bus bars, and the plurality of battery cells may include: a first battery cell provided with a first lead tab; a second battery cell provided with a second lead tab, and disposed adjacently to the first battery cell in a stacking direction in which the plurality of battery cells are stacked; a third battery cell provided with a third lead tab, and disposed adjacently to the second battery cell in the stacking direction; and a fourth battery cell provided with a fourth lead tab, and disposed adjacently to the third battery cell in the stacking direction, and the first lead tab and the second lead tab may be at least partially bent toward each other and connected to each other, and the third lead tab and the fourth lead tab may be at least partially bent toward each other and connected to each other.

According to an embodiment, the flow hole may be disposed between the second battery cell and the third battery cell.

Additionally, a battery module of the present disclosure may include: a plurality of battery cells stacked in a first direction; a housing having an accommodation space in which the plurality of battery cells are accommodated, and including a lower cover supporting lower portions of the plurality of battery cells and an upper cover covering upper portions of the plurality of battery cells; a first cooling port which is provided in the housing and through which cooling fluid introduced into the accommodation space flows;

a second cooling port which is provided in the housing so as to face the first cooling port in a second direction, perpendicular to the first direction, and through which the cooling fluid discharged from the accommodation space flows;

a first flow plate in contact with the upper cover and disposed between the plurality of battery cells and the upper cover, and provided to cool the plurality of battery cells; and a second flow plate in contact with the lower cover and disposed between the plurality of battery cells and the lower cover, and provided to cool the plurality of battery cells, and each of the first flow plate and the second flow plate may include a plurality of flow channels extending in the second direction to guide the cooling fluid in the second direction but are arranged in the first direction.

Described above, the solutions according to the present disclosure have been described, but they are exemplary, and it should be understood that other configurations that are not mentioned are also included in the present disclosure.

A battery module according to an embodiment of the present disclosure may effectively perform heat exchange between a battery cell and a cooling fluid.

A battery module according to an embodiment of the present disclosure may smoothly flow a cooling fluid in a space between a housing and a battery cell inside a battery module.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module in accordance with an embodiment of the present disclosure;

FIG. 2 is an exploded perspective view of a battery module according to an embodiment of the present disclosure;

FIG. 3 is a cross-sectional view taken along line I-I′ of FIG. 1;

FIG. 4 is a cross-sectional view taken along line II-II′ of FIG. 1, and is a view illustrating a state excluding a flow plate;

FIG. 5 is a view illustrating an arrangement structure of a flow plate according to a first embodiment of the present disclosure;

FIG. 6 is a front view of a bus bar assembly according to the first embodiment of the present disclosure;

FIG. 7 is a view illustrating an arrangement structure of a flow plate according to a second embodiment of the present disclosure;

FIG. 8 is a front view of a bus bar assembly according to the second embodiment of the present disclosure; and

FIG. 9 is a plan view of FIG. 8 viewed from above.

### DETAILED DESCRIPTION

Prior to describing the embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation.

The same reference numbers or symbols described in each drawing represent components or elements that perform substantially the same functions. For convenience of description and understanding, the same reference numbers or symbols may be used in different embodiments.

The singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Furthermore, hereinafter, it should be noted in advance that the expressions such as “above,” “upper,” “below,” “beneath,” “lower,” “side,” “front,” and “rear” are based on the direction illustrated in the drawings, and may be expressed differently if the direction of the object is changed.

In addition, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, the present disclosure will be described in detail with reference to the drawings.

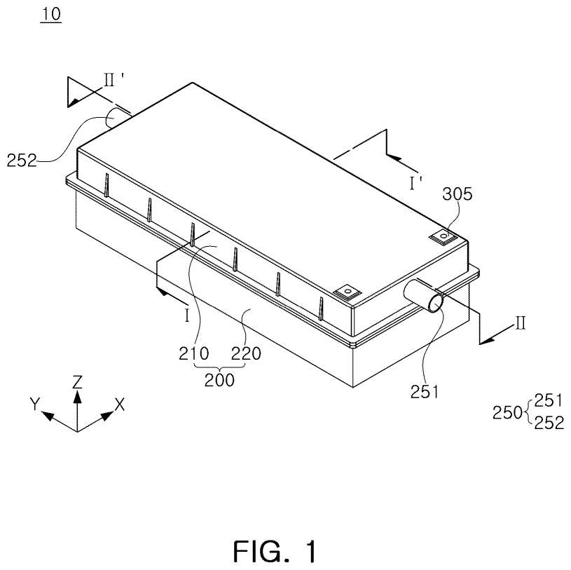

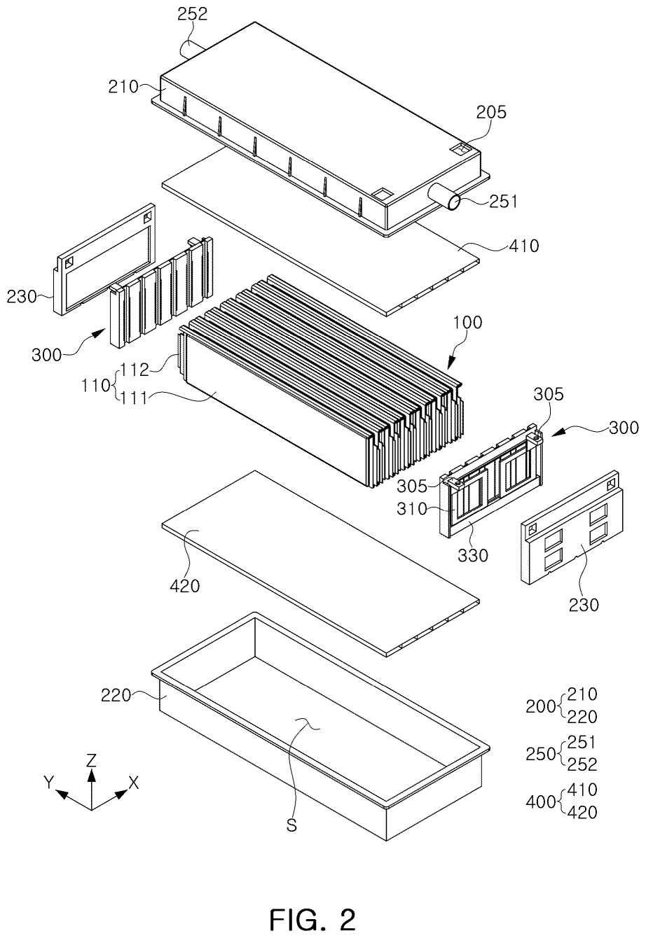

FIG. 1 is a perspective view of a battery module in accordance with an embodiment of the present disclosure, and FIG. 2 is an exploded perspective view of a battery module according to an embodiment of the present disclosure.

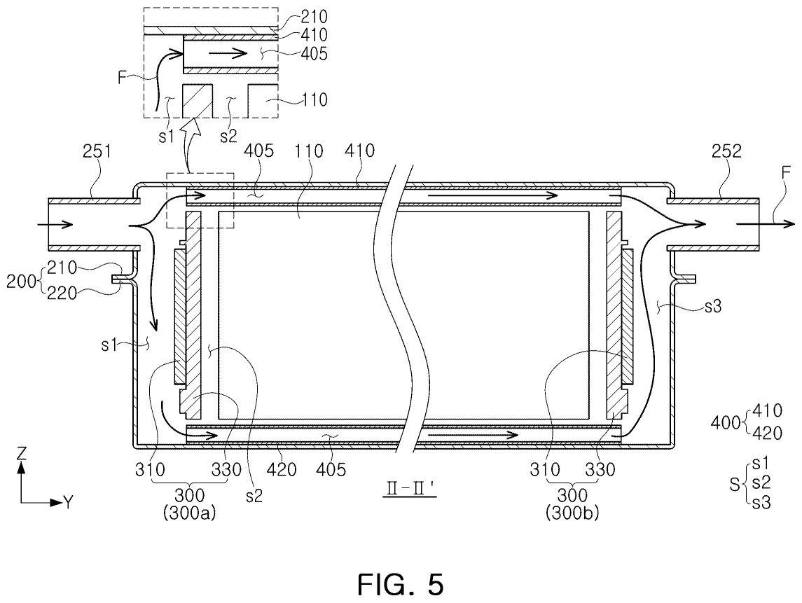

Referring to FIGS. 1 and 2 together, a battery module according to an embodiment of the present disclosure may include: a housing 200 having an accommodation space S therein, a cell assembly 100 including a plurality of battery cells 110 accommodated in the accommodation space S of the housing 200, a busbar assembly 300 electrically connected to the plurality of battery cells 110, and a flow plate 400 disposed on at least one side of the cell assembly 100 to allow a cooling fluid F (see FIG. 5) to flow therethrough.

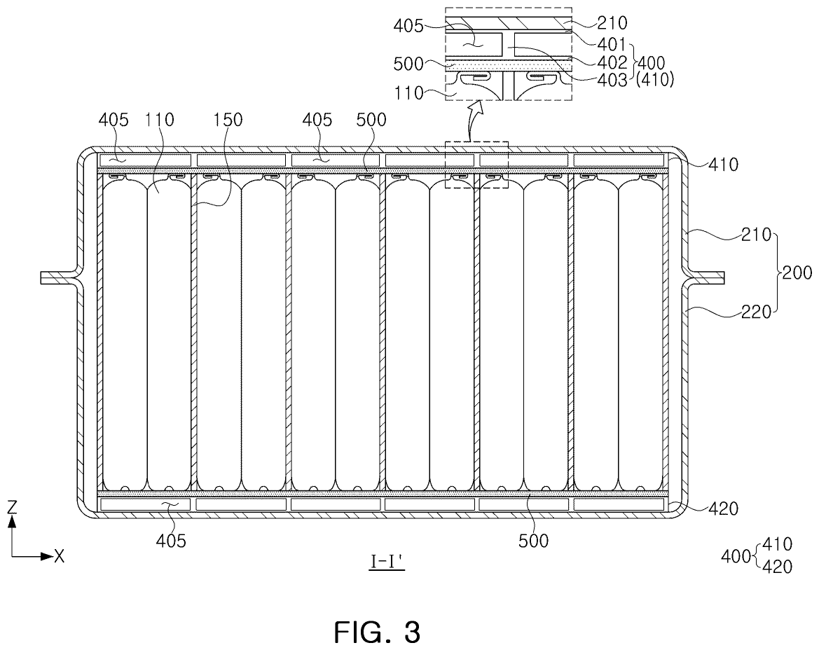

More specifically, a battery module 10 according to an embodiment of the present disclosure may include a housing 200 having an accommodation space S, a cell assembly 100 accommodated in the accommodation space S and including a plurality of battery cells 110, a first cooling port 251 through which the cooling fluid F flows into the accommodation space S, a second cooling port 252 which is disposed to face the first cooling port 251 in a longitudinal direction (Y-axis direction or first direction) and through which the cooling fluid F is discharged to the outside of the accommodation space S, and a flow plate 400 provided with a plurality of flow channels 405 (see FIG. 3) extending in the longitudinal direction (Y-axis direction or first direction) so that the cooling fluid F flows in the longitudinal direction (Y-axis direction or first direction), and the flow plate 400 may be disposed on at least one side of the cell assembly 100 based on a height direction (Z-axis direction or second direction), perpendicular to the longitudinal direction (Y-axis direction or first direction). Here, being disposed on at least one side of the cell assembly 100 may denote that the flow plate 400 is disposed in at least one space of a space between the cell assembly 100 and an upper cover 210 or a space between the cell assembly 100 and the lower cover 220.

Hereinafter, each component of the present disclosure will be described.

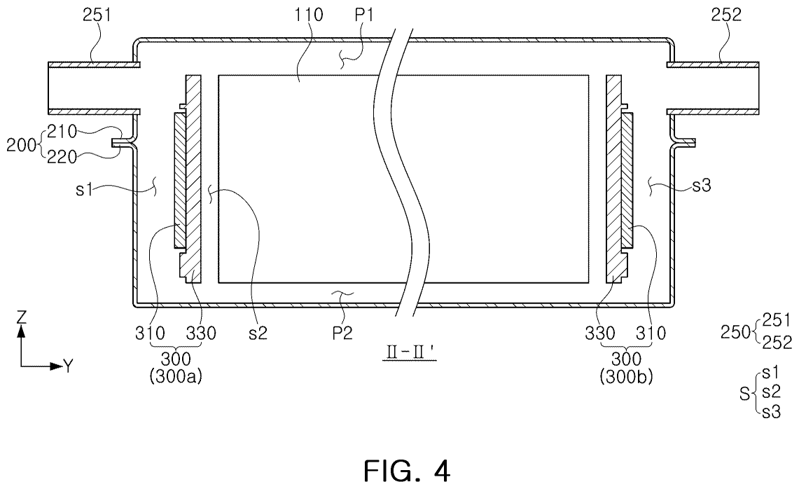

The housing 200 may include a lower cover 220 provided to support a lower portion of the cell assembly 100, and an upper cover 210 disposed to face the lower cover and covering the cell assembly 100. According to an embodiment, the flow plate 400 may be disposed in at least one of a space (a first separation space P1 of FIG. 4 to be described below) between the cell assembly 100 and the upper cover 210 or a space (a second separation space P2 of FIG. 4 to be described below) between the cell assembly and the lower cover. That is, the flow plate 400 may be disposed in at least one of an upper portion or a lower portion of the cell assembly 100.

However, in the present disclosure, the flow plate 400 may also be disposed on both sides of the cell assembly 100. According to an embodiment, the flow plate 400 may include a first flow plate 410 disposed in the space between the cell assembly 100 and the upper cover 210 and a second flow plate 420 disposed in the space between the cell assembly 100 and the lower cover 220 and facing the first flow plate 410 in the height direction (Z-axis direction or second direction).

By means of such a structure, when a venting gas is generated in the battery cell 110 due to thermal runaway, the venting gas may be prevented from being discharged upwardly (+Z-axis direction) and downwardly (−Z-axis direction). Additionally, since the plurality of battery cells 110 are disposed to be wedged between the first and the second flow plate 410, 420, mechanical restraint force of the plurality of battery cells 110 may be maintained despite the flow of the cooling fluid F.

According to an embodiment, the first flow plate 410 may be in contact with the upper cover 210, and the second flow plate 420 may be in contact with the lower cover 220.

The upper cover 210 and the lower cover 220 may be coupled to each other to form an accommodation space S in which the cell assembly 100 is accommodated. In the drawing, the upper cover 210 and the lower cover 220 are illustrated as having a shape like ‘[’ that is bent to at least partially surround a side portion of the cell assembly 100, but the present disclosure is not limited thereto.

In an embodiment of the present disclosure, the housing 200 may include a material having a predetermined rigidity, such as a metal. For example, the housing 200 may include aluminum and/or stainless steel. However, the housing 200 of the present disclosure is not limited to the materials described above. For example, as long as the housing 200 is provided with a solid material that may support while forming the accommodation space S in which the cell assembly 100 is accommodated, the housing 200 will all fall within the scope of the present disclosure.

Additionally, according to an embodiment of the present disclosure, the housing 200 may include a terminal hole 205 provided so that a terminal portion 305 of the busbar assembly 300 is exposed. In the drawing, the terminal hole 205 is illustrated as being formed in the upper cover 210, but this is only an example, and the terminal hole 205 may be disposed on a lower surface or a side surface of the housing 200.

Meanwhile, according to an embodiment of the present disclosure, the internal accommodation space S of the battery module 10 may be provided so that the cooling fluid F flows. According to an embodiment, the housing 200 may include a cooling port 250 provided so that the cooling fluid F flows by communicating with an external flow. The cooling fluid F may be introduced into the interior of the housing 200 and may exchange heat with the plurality of battery cells 110 to cool the plurality of battery cells 110.

The cooling port 250 may include a first cooling port 251 through which the cooling fluid F introduced into the interior of the housing 200 flows, and a second cooling port 252 through which the cooling fluid F discharged from the interior of the housing 200 to the outside flows. In the present disclosure, the first cooling port and the second cooling ports 251 and 252 may not only denote passages through which the cooling fluid F is introduced or discharged, but may also denote both introducing and discharging the cooling fluid F by directly applying power. According to an embodiment, the first cooling port 251 and the second cooling port 252 may be disposed to face each other in the longitudinal direction (Y-axis direction) of the module.

Meanwhile, for the convenience of understanding, although omitted in the drawing, each of the first cooling port 251 and the second cooling port 252 may be connected to a hose provided so that the cooling fluid F to flow. That is, the first cooling port 251 may communicated with a hose for supplying the cooling fluid F, and the second cooling port 252 may communicated with a hose for discharging the cooling fluid F of the housing 200.

Additionally, according to an embodiment, the first cooling port 251 and the second cooling port 252 may be disposed to face each other in a predetermined direction. That is, in order to improve the flowability of the cooling fluid F, the first cooling port 251 and the second cooling port 252 may be disposed in the housing 200 to face each other. For example, the first cooling port 251 and the second cooling port 251 may be disposed to face each other in the longitudinal direction (Y-axis direction) of the battery 110. However, the present disclosure is not limited to an arrangement structure of the cooling ports, and if the first cooling port 251 (e.g., an inlet port) and the second cooling port 252 (e.g., an outlet port) into which the cooling fluid F flows are included, this will all belong to the present disclosure.

Meanwhile, the “cooling fluid F” of the present disclosure is a fluid acting as an electrical insulator, and may be, for example, an insulating oil having non-conductive oil as a main component thereof. However, the cooling fluid F of the present disclosure is not limited thereto, and any fluid that has a property of cooling the battery cell 110 through heat exchange with the battery cell 110 will belong to the present disclosure.

Additionally, the battery module 10 of the present disclosure may further include an insulating cover 230 disposed between the cell assembly 100 and the housing 200. The insulating cover 230 may be provided with an electrically insulating material to prevent electrical short circuits between the cell assembly 100 and the housing 200. In the drawing, the insulating covers 230 are illustrated as being provided as a pair so that a pair of insulating covers are disposed to face each other in the longitudinal direction (Y-axis direction) of the cell assembly 100, but the present disclosure is not limited thereto and the pair of insulating covers are disposed may also be disposed in a thickness direction (X-axis direction). That is, an insulating cover 240 of the present disclosure is not particularly limited as long as this has a structure disposed between the housing 200 and the cell assembly 100. The insulating cover 230 may be provided with a through-hole (not illustrated) formed to allow the cooling fluid F to pass therethrough so that the cooling fluid F introduced from the cooling port 250 may pass through the through-hole.

According to an embodiment of the present disclosure, a cell assembly 100 including a plurality of battery cells 110 may be included. The cell assembly 100 may be formed by stacking a plurality of battery cells 110 in the thickness direction (X-axis direction). Meanwhile, the cell assembly 100 of the present disclosure may further include a cell pad 150 disposed between the plurality of battery cells 110 to block heat between adjacent plurality of battery cells 110 or to absorb expansion of the adjacent plurality of battery cells 110. However, the cell pad 150 is only one example of the present disclosure, and the present disclosure is not limited to whether or not a blocking pad is provided, and only a plurality of battery cells 110 may be provided.

The battery cell 110 may be a secondary battery. For example, the battery cell 110 may be a lithium ion battery, but the present disclosure is not limited thereto. For example, the battery cell 110 may be a nickel-cadmium battery, a nickel-metal hydride battery or a nickel-hydrogen battery, capable of being charged or discharged therein or therefrom.

The battery cell 110 may include a case 111 accommodating an electrode assembly (not illustrated) and a lead tab 112 disposed on at least one side of the case 111.

In the electrode assembly, a cathode plate and an anode plate may be stacked in a predetermined direction, and a separator may be interposed therebetween. The separator may be disposed between the cathode plate and the anode plate to prevent a short circuit between the cathode plate and the anode plate. The separator may be configured to prevent an electrical short circuit between the cathode plate and the anode plate and to allow for the flow of ions. As an example, the separator may include a porous polymer film or a porous nonwoven fabric. According to example embodiments, the electrode assembly may be formed by alternately and repeatedly stacking the cathode plate, the anode plate, and the separator in the above-described order. Additionally, in some embodiments, the electrode assembly may be a winding type electrode assembly, a stacking type electrode assembly, a zigzag folding type electrode assembly, or a stack-folding type electrode assembly.

The case 111 may accommodate the electrode assembly and the electrolyte described above and may form an outer appearance of the battery cell 110. In the drawing, the case illustrated as a pouch-type battery cell that accommodates the electrode assembly in an internal space of the pouch and seals the inner space by fusing at least one edge thereof, but the present disclosure is not limited thereto.

In an embodiment of the present disclosure, the lead tab 112 may be disposed on at least one side of the battery cell 110 and may be electrically connected to the busbar assembly 300 described below. For example, the lead tab 112 may be disposed on both sides of the longitudinal direction (Y-axis direction) of the battery cell 110. In this case, one of the two sides may be a cathode tab having a cathode polarity, and the other thereof may be an anode tab having an anode polarity. However, the battery cell 110 of the present disclosure is not limited to the arrangement structure of the lead tab 112 described above. For example, the cathode tab and the anode tab of the lead tab 112 described above may both be disposed on one side in the longitudinal direction (Y-axis direction) of the battery cell 110.

In this manner, the lead tab 112 of the battery cell 110 of the present disclosure is not limited to the specific position described above as long as this is electrically connected to a busbar assembly 300 to be described below.

The busbar assembly 300 may be provided so that the cell assembly 100 and the cooling port 250 are disposed to face each other in a direction (longitudinal direction or first direction or Y-axis direction) in which the cell assembly 100 and the cooling port 250 face each other, and may thus be electrically connected to the plurality of battery cells 110. For example, the busbar assembly 300 may be disposed so as to face the cell assembly 100 in a protruding direction (longitudinal direction or Y-axis direction) of the lead tab 112.

According to an embodiment, the busbar assembly 300 may be disposed so as to face the cooling port 250.

Additionally, according to an embodiment, the busbar assembly 300 may include a first busbar assembly 300a disposed on one side of the cell assembly 100 and a second busbar assembly 300b disposed on the other side of the cell assembly 100. The first busbar assembly 300a and the second busbar assembly 300b are named to distinguish positions of the busbar assembly 300 relative to the cell assembly 100, and may include the same components.

The busbar assembly 300 may include a plurality of busbars 310 electrically connected to the plurality of battery cells 110 and a support frame 330 on which the plurality of busbars 310 are disposed. Additionally, the busbar assembly 300 may include a terminal portion 305 provided on at least one of the plurality of busbars 310 and electrically connected to an external power source. Here, the term ‘external power source’ may denote an external power source of a corresponding battery module 10 on which a corresponding terminal portion 305 is disposed. In other words, the battery module 10 may refer not to a specific one battery module, but the other battery module.

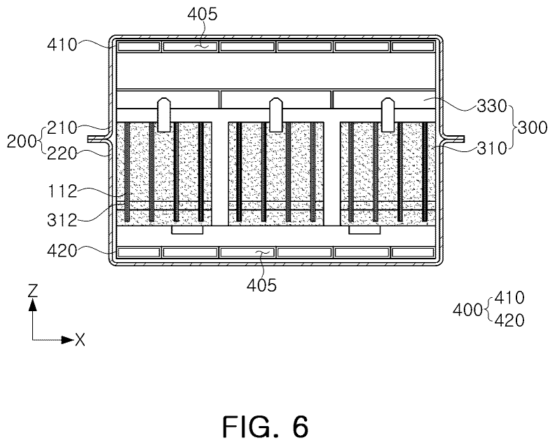

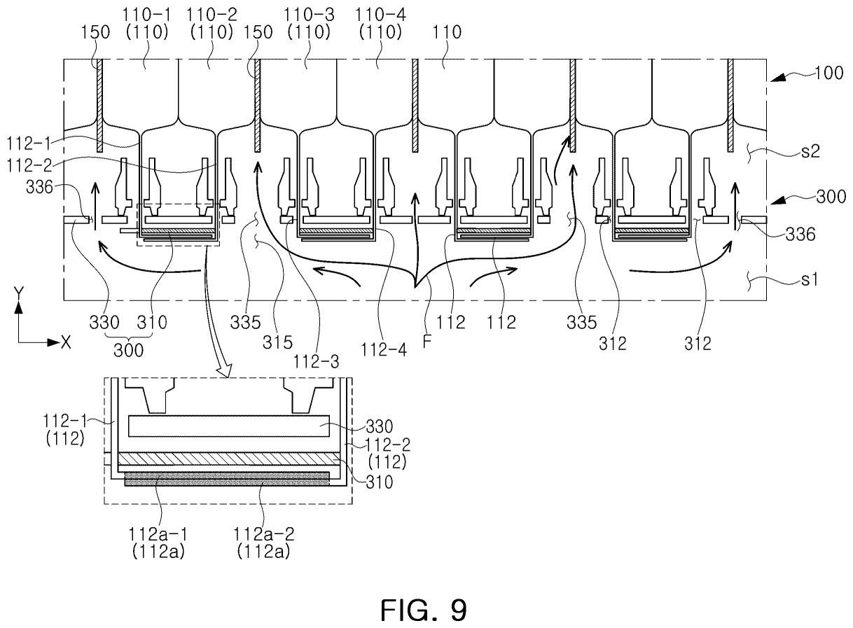

The bus bar 310 may include an electrically conductive material such as a metal so as to be electrically connected to at least one of the plurality of battery cells 110. The bus bar 310 may be provided in plural. Each of the bus bars 310 may be provided with a slit hole 312 (see FIGS. 6 and 9) into which at least a portion of the lead tab 112 of the battery cell 110 is inserted.

Additionally, the support t frame 330 may also be provided with a slit groove (not illustrated) formed in a position corresponding to the slit hole 312 so that at least a portion of the battery cell 110 may be inserted thereinto.

Accordingly, at least a portion of the battery cell 110 may enter through the slit groove of the support frame 330, and the lead tab 112 may be simultaneously inserted into the slit hole 312 of the bus bar 310. Accordingly, the battery cell 110 and the bus bar 310 may be electrically connected.

The support frame 330 may be provided to support the bus bar 310. The support frame 330 may be provided with an electrically insulating material to prevent a short circuit between the plurality of bus bars 310. The support frame 330 may be disposed between the cell assembly 100 and the bus bar 310.

The terminal portion 305 may extend from at least one of the plurality of bus bars 310 and may be electrically connected to an external power source. According to an embodiment, the terminal portion 305 may extend in a state of being formed integrally with at least one of the plurality of bus bars 310.

The flow plate 400 of the present disclosure may include at least one flow channel 405 provided so that the cooling fluid F flows. The cooling fluid F injected into the accommodation space S may be provided to flow through the flow plate 400.

According to an embodiment, the flow plate 400 may be disposed in least one of a space between the cell assembly 100 and the upper cover 210 or a space between the cell assembly 100 and the lower cover 220. For example, the flow plate 400 may be disposed on both sides of the cell assembly 100, e.g., an upper portion (+Z-axis direction) and a lower portion (−Z-axis direction) thereof, or may be disposed in either the upper portion or the lower portion of the cell assembly 100.

Hereinafter, the structure of the flow plate 400 of the present disclosure will be described in detail.

FIG. 3 is a cross-sectional view taken along line I-I′ of FIG. 1.

Referring to FIG. 3 together, the flow plate 400 of the present disclosure may be disposed on at least one side of the cell assembly 100, thereby exchanging heat with the plurality of battery cells 110. The flow plate 400 may include a material such as a metal having high thermal conductivity for heat exchange.

The flow plate 400 may include at least one flow channel 405 provided to allow the cooling fluid F introduced through the cooling port 250 to pass therethrough.

According to an embodiment, the flow channel 405 may be provided to extend long in the longitudinal direction of the module (Y-axis direction or arrangement direction of the cooling port), so that the cooling fluid F may flow smoothly in the longitudinal direction.

According to an embodiment, the flow plate 400 may include a plurality of flow channels 405, and the plurality of flow channels 405 may be disposed in a stacking direction (X-axis direction or third direction) of the battery cells 110. In this case, each of the flow channels 405 may extend in the longitudinal direction (Y-axis direction or flow direction of the cooling fluid F) of the battery cells 110 as described above.

According to an embodiment, the flow plate 400 may include a first flow plate 410 disposed between the upper cover 210 and the cell assembly 100 and a second flow plate 420 disposed between the lower cover 220 and the cell assembly 100.

Each of the first flow plate 410 and the second flow plate 420 may include a first plate 401 disposed to face the housing 200, a second plate 402 disposed to face the cell assembly, and a partition frame 403 disposed between the first plate 401 and the second plate 402 so as to form an interior of the flow plate 400 into a plurality of flow channels 405.

The cooling fluid F introduced into the accommodation space S may be introduced into the flow channel 405 and may flow in a space between the battery cell 110 and the housing 200. The flow plate 400 may be cooled by the cooling fluid F introduced into the flow channel 405, and the flow plate 400 may exchange heat with the battery cell 110 and may consequently cool the battery cell 110.

Additionally, according to the present disclosure, a heat transfer member 500 may be disposed between the flow plate 400 and the cell assembly 100. The heat transfer member 500 may include a material having high thermal conductivity to easily perform heat exchange between the flow plate 400 and the battery cell 110.

According to an embodiment, the heat transfer member 500 may include a thermal adhesive for adhering the flow plate 400 and the cell assembly 100 to each other.

The adhesive may be provided with a material which has a thermal conductivity of 3 W/km or less and which is not reactive with the cooling fluid F. In this case, a thickness (e.g., a size in the Z-axis direction) of the thermal adhesive may be 0.2 mm to 0.5 mm. However, the heat transfer member 500 of the present disclosure is not limited thereto.

For example, the heat transfer member 500 may be provided as an adhesive pad. Accordingly, one surface of the heat transfer member 500 may be adhered to the cell assembly 100 and the other surface opposite thereto may be adhered to the flow plate 400.

A contact area between the flow plate 400 and the battery cell 110 may be increased in terms of heat exchange, thereby increasing the heat exchange effect. However, this is only an embodiment, and any structure in which the heat transfer member is disposed between the flow plate 400 and the cell assembly 100 for heat exchange may be considered to belong to the heat transfer member 500 of the present disclosure.

FIG. 4 is a cross-sectional view taken along line II-II′ of FIG. 1, and is a view illustrating a state excluding the flow plate. For convenience of understanding, FIG. 4 omits structures of the insulating cover 230, the heat transfer member 500, the flow plate 400, and the like, in order to explain in detail a space and a structure through which the cooling fluid F flows.

Referring to FIG. 4, in a battery module 10 according to an embodiment, the first cooling port 251 and the second cooling port 252 may be disposed to face each other in the longitudinal direction (Y-axis direction) with the cell assembly 100 interposed therebetween. Additionally, the first busbaOr assembly 300a may be disposed between the first cooling port 251 and the cell assembly 100, and the second busbar assembly 300b may be disposed between the second cooling port 252 and the cell assembly 100.

The busbar assembly 300 may divide the accommodation space S into a plurality of spaces. In an embodiment, the busbar assembly 300 may be divided into a space between the housing 200 and the first busbar assembly 300a, which is a first space s1 (e.g., an inlet space) into which the cooling fluid F is introduced, a space between the first and second busbar assemblies 300a and 300b, which is a second space s2 (e.g., a heat exchange space) into which the cell assembly 100 is disposed, and a space between the second busbar assembly 300b and the housing 200, which is a third space s3 (e.g., a discharge space) into which the cooling fluid F is discharged.

In other words, according to an embodiment, the accommodation space S may include the first space s1 between the first cooling port 251 and the first busbar assembly 300a, a second space s2 in which the cell assembly 100 is disposed and which is between the first busbar assembly 300a and the second busbar assembly 300b, and a third space s3 between the second busbar assembly 300b and the second cooling port 252. In this case, according to an embodiment, the flow plate 400 may be disposed in the second space s2.

The cooling fluid F may flow into the first space s1 from the first cooling port 251 and may flow into the second space s2 by passing through the first busbar assembly 300a to exchange heat with the battery cells 110, and the heated cooling fluid F may flow into the third space s3 by passing through the second busbar assembly 300b and then may be discharged to the outside of the housing 200 through the second cooling port 252. Here, based on a flow direction of the cooling fluid F flowing in the accommodation space S through the cooling port 250, the first space s1 may be an upstream side, and the third space s3 may be a downstream side.

Meanwhile, in the present disclosure, ‘dividing the accommodation space S into a plurality of spaces’ may not only denote physically separating one space from another space so that fluid does not pass therethrough, but may have a comprehensive meaning that includes dividing the space based on a space in which a difference in the flow of fluid occurs between one space and another space. In other words, this may denote dividing the accommodation space S into a plurality of spaces based on the busbar assembly 300.

The accommodation space S may include the first space s1 between the housing 200 and the first busbar assembly 300a, the second space s2 between the first and second busbar assemblies 300a and 300b, and the third space s3 between the second busbar assembly 300b and the housing 200, based on a direction (longitudinal direction or Y-axis direction) in which the cooling port 250 faces.

Meanwhile, the second space s2, which is the space in which the cell assembly 100 is disposed, may be a space in which heat exchange occurs between the cooling fluid F and the plurality of battery cells 110. Accordingly, the flow plate 400 may be disposed in the second space s2.

Additionally, the second space s2 may include a first flow space P1, which is a space between the cell assembly 100 and the upper cover 210, and a second flow space P2, which is a space between the cell assembly 100 and the lower cover 220. The cooling fluid F may flow into the first flow space P1 and the second space P2.

According to an embodiment, the flow plate 400 may be arranged in at least one of the first flow space P1 and the second flow space P2. The first flow plate 410 may be disposed in the first flow space P1, and the second flow plate 420 may be disposed in the second flow space P2. In this case, since the cooling fluid F flowing into the first and second flow spaces P1 and P2 flows through the flow channel 405, the flowability of the cooling fluid F may be improved and the heat exchange efficiency with the battery cell 110 may be increased.

Meanwhile, according to an embodiment, the busbar assembly 300 and the cooling port 250 may be disposed to face each other based on the longitudinal direction (Y-axis direction or fluid flow direction). Additionally, the cooling fluid F may pass through the busbar assembly 300 and flow into the flow plate 400.

Hereinafter, an arrangement structure of the flow plate 400 according to a first embodiment of the present disclosure will be described.

FIG. 5 is a view illustrating the arrangement structure of the flow plate according to the first embodiment of the present disclosure, and FIG. 6 is a front view of the busbar assembly according to the first embodiment of the present disclosure.

Referring to FIG. 5, in the battery module 10 according to the first embodiment, the cooling fluid F may be introduced into the flow channel 405 from the first space s1.

According to the first embodiment, the busbar assembly 300 and the housing 200 may be spaced apart from each other in the height direction (Z-axis direction). The cooling fluid F introduced into the first space s1 through the first flow port 251 may pass through the spacing gap and may be introduced into the flow channel 405. In other words, the busbar assembly 300 may be spaced apart from the housing 200 by a predetermined distance based on the height direction (Z-axis direction or second direction) and may thus be provided so that the cooling fluid F of the first space s1 may flow into the second space s2 through the spacing gap.

The cooling fluid F introduced into the flow channel 405 may flow into the third space s3 through the spacing gap again and may then be discharged to the outside through the second flow port 252.

In other words, the cooling fluid F introduced into the first space s1 through the first cooling port 251 may be introduced directly into the flow plate 400 through a space between the busbar assembly 300 and the housing 200. Accordingly, the cooling fluid F in a relatively low temperature state may be allowed to exchange heat with the battery cell 110.

Additionally, according to an embodiment, as illustrated in the drawing, the flow plate 400 may extend in the longitudinal direction (Y-axis direction or first direction), so that at least one side thereof may be disposed between the busbar assembly 300 and the housing 200. In other words, the flow plate 400 may be disposed to extend further in the flow spaces P1 and P2 in the longitudinal direction, so that at least a portion thereof overlaps the busbar assembly 300 in the height direction (Z-axis direction).

Referring to FIG. 6, the busbar 310 may be provided with a slit hole 312 into which a lead tab 112 may be inserted. According to an embodiment, the flow plate 400 may be disposed in the space between the busbar assembly 300 and the housing 200. The cooling fluid F introduced from the first cooling port 251 may be introduced into the flow channel 405.

In this manner, according to the first embodiment, a main stream of the cooling fluid F may be introduced into the flow channel 405 through a space between the first busbar assembly 300 and at least one of the upper cover 210 or the lower cover 220 in the first space s1.

Accordingly, in the first embodiment, the cooling fluid F may flow through a relatively shortest route toward the flow channel 405 of the flow plate 400 in the first space s1.

Hereinafter, an arrangement structure of the flow plate 400 according to a second embodiment of the present disclosure will be described.

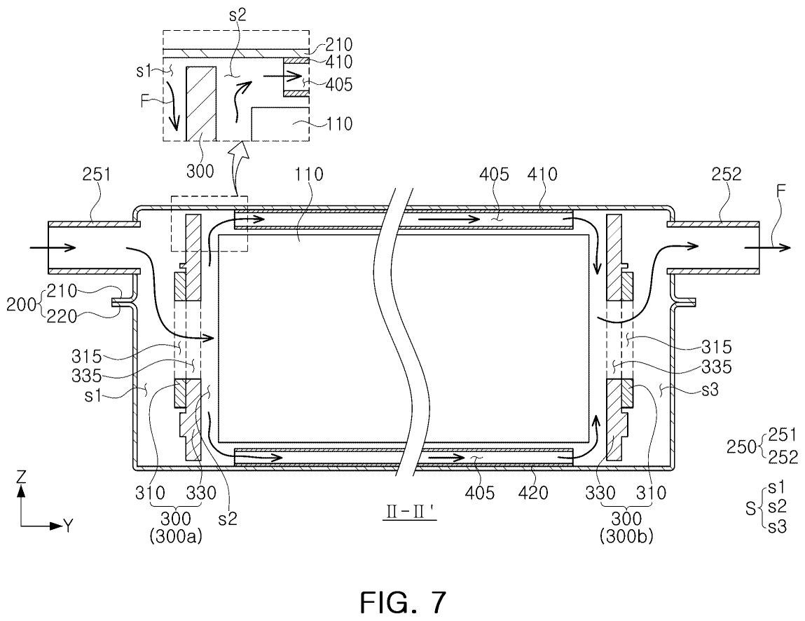

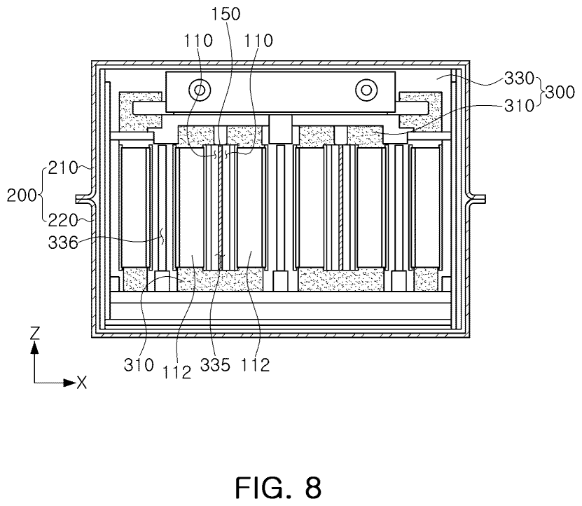

FIG. 7 is a view illustrating the arrangement structure of the flow plate according to the second embodiment of the present disclosure, FIG. 8 is a front view of the busbar assembly according to the second embodiment of the present disclosure, and FIG. 9 is a plan view of FIG. 8 as viewed from above.

Referring to FIGS. 7 and 8 together, in a battery module 10 according to the second embodiment, cooling fluid F may flow into a second space s2 and then flow into a flow channel 405.

According to the second embodiment, the busbar assembly 300 may have a hole formed for the cooling fluid F to pass therethrough. The busbar 310 may include a bus hole 315 through which the cooling fluid F passes, and a flow hole 335 may be formed in a support frame 330 supporting the busbar 310. The bus hole 315 and the flow hole 335 may communicate with each other and may thus be passages through which the cooling fluid F moves from the first space s1 to the second space s2. In other words, at least one of the plurality of bus bars 310 may include the bus hole 315 through which cooling fluid F passes, and the support frame 330 may include at least one flow hole 335 which communicates with the bus hole 315 and through which the cooling fluid F passes.

Through such a structure, the cooling fluid F introduced into the first space s1 through the first flow port 251 may be introduced into the second space s2 through the bus hole 315 and flow hole 335. The cooling fluid F introduced into the second space s2 may collide with the cell assembly 100 and may flow toward the upper cover 210 and the lower cover 220 and may then be introduced into the flow channel 405 of the flow plate 400.

The cooling fluid F introduced into the flow channel 405 may similarly flow into the third space s3 while exchanging heat with a plurality of battery cells 110, and may then be discharged to the outside through the second cooling port 252. The cooling fluid F may flow to the space s3 and may then be discharged to the outside through the second flow port 252.

Accordingly, the cooling fluid F may directly exchange heat between a front surface (−Y-axis direction) and a rear surface (+Y-axis direction) of the battery cell 110, and may simultaneously perform heat exchange between an upper surface (+Z-axis direction) and a lower surface (−Z-axis direction) of the battery cell 110 through the second plate of the flow plate 400.

Additionally, according to the second embodiment, in order to increase the flowability and flow amount of the cooling fluid F, the support frame 330 may be further provided with a support hole 336 through which the cooling fluid F may pass in addition to the flow hole 335. The flow hole 335 and the support hole 336 may be formed alternately in a stacking direction (X-axis direction) of the battery cells 110. In other words, the support frame 330 may include at least one support hole 336 formed between the plurality of bus bars 310 and provided to allow the cooling fluid F to pass therethrough, and the support hole 336 and the flow hole 335 may be disposed alternately in a stacking direction (X-axis direction) of the plurality of battery cells.

Meanwhile, according to the second embodiment, the bus bar assembly 300 may be disposed closer to the upper cover 210 and the lower cover 220 than in the first embodiment. Accordingly, the cooling fluid F may be guided to flow into the bus hole 315 and the flow hole 335.

However, this is only one example, and similarly to the first embodiment, the busbar assembly 300 may be spaced apart from the upper cover 210 and the lower cover 220, so that the cooling fluid F may flow from the spacing gap. In other words, as in the first embodiment, the cooling fluid F may not only flow into the flow plate 400 through the busbar assembly 300 and the upper cover 210 and the lower cover 220, but may also flow through the busbar assembly 300 into the second space s2 and then flow into the flow plate 400.

That is, any structure in which the cooling fluid F passes through the bus hole 315 and the flow hole 335 formed in the busbar assembly 300, flows into the second space s2, and then flows into the flow channel 405 will all belong to the second embodiment.

Meanwhile, according to the second embodiment, in order to secure a space of the flow hole 335, lead tabs 112 of adjacent battery cells 110 may be disposed so that at least portions thereof overlaps each other. In this case, a portion in which the lead tabs 112 of the adjacent battery cells 110 are in contact with or overlap each other is knowns as a coupling portion 112a. For example, the adjacent battery cells 110 may be coupled to each other by butt-welding the coupling portion 112a to the bus bar 310.

Referring to FIG. 9, a structure of the flow hole 335 through which the cooling fluid F passes will be described in more detail.

Referring to FIG. 9, a first battery cell 110-1 and a second battery cell 110-2 adjacent to each other in a stacking direction (X-axis direction or thickness direction) of the battery cells 110 may be disposed so that at least portions of each of lead tabs 112-1 and 112-2 overlap the bus bar 310. In this case, a portion in which each of the lead tabs 112-1 and 112-2 overlaps or contacts each other is referred to as coupling portions 112a-1 and 112a-2. The first coupling portion 112a-1 and the second coupling portion 112a-2 may be in contact with each other to face the bus bar 310 and may be welded to each other.

Additionally, in the second battery cell 110-2, a third battery cell 110-3 adjacent thereto, and a fourth battery cell 110-4 adjacent thereto, similarly, at least portions of each of lead tabs 112-3 and 112-4 may be connected to the bus bar 310 by butt-welding. In this case, portions in which each of the lead tabs 112-3 and 112-4 overlaps or contacts each other are referred to as coupling portions 112a-3 and 112a-4. The third coupling portion 112a-3 and the fourth coupling portion 112a-4 may be in contact with each other to face the bus bar 310 and may be welded to each other. In this case, a cooling fluid F may be provided to flow between a pair of battery cells 110-1 and 110-2 and battery cells 110-3 and 110-4 adjacent thereto.

In other words, each of the plurality of battery cells 110 may include the lead tab 112 electrically connected to at least one of the plurality of bus bars 310, and the plurality of battery cells 110 may include the first battery cell 110-1 provided with the first lead tab 112-1, the second battery cell 110-2 provided with the second lead tab 112-2 and disposed adjacently to the first battery cell 110-1 in the stacking direction (X-axis direction) in which the plurality of battery cells 110 are stacked, the third battery cell 110-3 provided with the third lead tab 112-3 and disposed adjacently to the second battery cell 110-2 in the stacking direction (X-axis direction), and the fourth battery cell 110-4 provided with the fourth lead tab 112-4 and disposed adjacent to the third battery cell 110-3 in the stacking direction (X-axis direction), and the first lead tab 112-1 and the second lead tab 112-2 may be at least partially bent toward each other and connected to each other, and the third lead tab 112-3 and the fourth lead tab 112-4 may be at least partially bent toward each other and connected to each other.

Here, the flow hole 335 may be disposed between the second battery cell 110-1 and the third battery cell 110-3.

In this manner, since the cooling fluid F is introduced into a front surface of the battery cells 110, the lead tab 112 that may generate a large amount of heat may be cooled first and then introduced into the flow channel 405.

Meanwhile, the first embodiment and the second embodiment described above are only one of several embodiments for explaining a structure in which the cooling fluid F is introduced into the flow channel 405, and the present disclosure is not limited thereto.

In other words, the present disclosure is not limited to the first and second embodiments, and any structure may belong to the present disclosure as long as the flow plate 400 including the flow channel 405 is disposed on at least one side surface of the plurality of battery cells 110.

Meanwhile, as described above, according to the present disclosure, the flow plate 400 may be disposed on both surfaces to cool an upper surface and a lower surface of the plurality of battery cells 110. Specifically, the battery module 10 according to an embodiment may include: the plurality of battery cells 110 stacked in the first direction (X-axis direction); the housing 200 having the accommodation space S in which the plurality of battery cells 110 are accommodated, and including the lower cover 220 supporting lower portions of the plurality of battery cells 110 and the upper cover 210 covering upper portions of the plurality of battery cells 110; the first cooling port 251 which is provided in the housing 200 and through which the cooling fluid F introduced into the accommodation space S flows; the second cooling port 252 which is provided in the housing 200 so as to face the first cooling port 251 in the second direction (Y-axis direction or longitudinal direction), perpendicular to the first direction (X-axis direction), and through which the cooling fluid F discharged to the outside from the accommodation space S flows; the first flow plate 410 in contact with the upper cover 210 and disposed between the plurality of battery cells 110 and the upper cover 210 to cool the plurality of battery cells 110; and the second flow plate 420 in contact with the lower cover 220 and disposed between the plurality of battery cells 110 and the lower cover 220 to cool the plurality of battery cells 110, and each of the first flow plate 410 and the second flow plate 420 may include a plurality of flow channels 405 which extend in the second direction (Y-axis direction or longitudinal direction) to guide the cooling fluid F in the second direction but are disposed in the first direction.

In this manner, according to the present disclosure, since the battery cells 110 are cooled by the flow plates 400 disposed in an upper portion and a lower portion thereof, the cell assembly 100 may not require a separate cooling fin. Additionally, since an upper surface and a lower surface of the battery cell 110 are cooled at the same time, the cooling efficiency of the battery module 10 may be increased.

Additionally, through such a structure, the mechanical restraint force of the battery cells 110 may be improved in a liquid immersion cooling structure in which the cooling fluid F flows into the accommodation space S, and the cooling performance may be maintained so that stable charging and discharging and cooling may be achieved. Additionally, according to the present disclosure, cooling may be performed through the flow plate 400 in an upper portion and a lower portion of the battery cell 110, thereby simplifying the assembly structure and shortening the process time. Additionally, since the flow plate 400 may be disposed in the upper portion and the lower portion of the battery cell 110, thereby suppressing the upward and downward flowing of a venting gas during thermal runaway of the battery cell 110 and inducing the venting gas in other directions (e.g., a longitudinal direction or a Y-axis direction).

Although various embodiments of the disclosed technology have been described in detail above, the scope of the disclosed technology is not limited thereto, and it will be apparent to those skilled in the art that modifications and variations could be made without departing from the scope of the disclosed technology as defined by the appended claims. In addition, some components may be deleted and implemented in the above-described example embodiments, and each of the embodiments may be combined and implemented with each other.

The contents described above is merely an example of applying the principles of the present disclosure, and other components may be further included without departing from the scope of the present disclosure.

What is claimed is:

1. A battery module, comprising:
a housing having an accommodation space;
a cell assembly accommodated in the accommodation space and including a plurality of battery cells;
a first cooling port through which a cooling fluid flows into the accommodation space;
a second cooling port, disposed to face the first cooling port in a first direction and through which the cooling fluid is discharged the outside of the accommodation space; and
a flow plate provided with a plurality of flow channels extending in the first direction to allow the cooling fluid to flow in the first direction in the accommodation space,
wherein the flow plate is disposed on at least one side of the cell assembly based on a second direction, perpendicular to the first direction.

2. The battery module of claim 1, wherein the housing includes a lower cover disposed below the cell assembly and an upper cover covering the cell assembly, and
the flow plate is disposed in at least one of a space between the cell assembly and the upper cover or a space between the cell assembly and the lower cover.

3. The battery module of claim 2, wherein the flow plate includes:
a first flow plate disposed in a space between the cell assembly and the upper cover; and
a second flow plate disposed in a space between the cell assembly and the lower cover, and facing the first flow plate based on the second direction.

4. The battery module of claim 1, wherein the flow plate includes:
a first plate facing the housing;
a second plate spaced apart from the first plate toward the cell assembly and facing the cell assembly; and
a partition frame disposed between the first plate and the second plate to form the plurality of flow channels.

5. The battery module of claim 1, wherein the plurality of battery cells are stacked in a direction, perpendicular to both the first direction and the second direction, and
the plurality of flow channels are arranged in a direction in which the plurality of battery cells are stacked.

6. The battery module of claim 1, further comprising a heat transfer member disposed between the flow plate and the cell assembly.

7. The battery module of claim 6, wherein the heat transfer member includes an adhesive for adhering the flow plate and the cell assembly to each other.

8. The battery module of claim 1, further comprising:
a busbar assembly facing the cell assembly based on the first direction and electrically connected to the plurality of battery cells.

9. The battery module of claim 8, wherein the busbar assembly includes a first busbar assembly disposed on one side of the cell assembly and a second busbar assembly disposed on the other side of the cell assembly, and
the accommodation space includes:
a first space between the first cooling port and the first busbar assembly;
a second space between the first busbar assembly and the second busbar assembly, in which the cell assembly is disposed and; and
a third space between the second busbar assembly and the second cooling port,
wherein the flow plate is disposed in the second space.

10. The battery module of claim 9, wherein the busbar assembly is spaced apart from the housing by a predetermined distance based on the second direction, so that the cooling fluid in the first space flows into the second space through the spacing gap.

11. The battery module of claim 10, wherein the flow plate extends in the first direction, and at least one side thereof is disposed between the busbar assembly and the housing.

12. The battery module of claim 9, wherein the busbar assembly includes a plurality of busbars electrically connected to the plurality of battery cells and a support frame supporting the busbars,
at least one of the plurality of busbars includes a bus hole provided to allow the cooling fluid to pass therethrough, and
the support frame includes at least one flow hole communicating with the bus hole and provided to allow the cooling fluid to pass therethrough.

13. The battery module of claim 12, wherein the support frame includes at least one support hole formed between the plurality of busbars and provided to allow the cooling fluid to pass therethrough, and
the support hole and the flow hole are arranged alternately in a direction in which the plurality of battery cells are stacked.

14. The battery module of claim 12, wherein each of the plurality of battery cells includes a lead tab electrically connected to at least one of the plurality of bus bars,
wherein the plurality of battery cells include:
a first battery cell provided with a first lead tab;
a second battery cell provided with a second lead tab, and disposed adjacently to the first battery cell in a stacking direction in which the plurality of battery cells are stacked;
a third battery cell provided with a third lead tab, and disposed adjacently to the second battery cell in the stacking direction; and
a fourth battery cell provided with a fourth lead tab, and disposed adjacently to the third battery cell in the stacking direction,
wherein the first lead tab and the second lead tab are at least partially bent toward each other and connected to each other, and the third lead tab and the fourth lead tab are at least partially bent toward each other and connected to each other.

15. The battery module of claim 14, wherein the flow hole is disposed between the second battery cell and the third battery cell.

16. A battery module, comprising:
a plurality of battery cells stacked in a first direction;
a housing having an accommodation space in which the plurality of battery cells are accommodated, and including a lower cover supporting lower portions of the plurality of battery cells and an upper cover covering upper portions of the plurality of battery cells;
a first cooling port which is provided in the housing and through which a cooling fluid introduced into the accommodation space flows;
a second cooling port which is provided in the housing so as to face the first cooling port in a second direction, perpendicular to the first direction, and through which the cooling fluid discharged from the accommodation space flows;
a first flow plate in contact with the upper cover and disposed between the plurality of battery cells and the upper cover, and provided to cool the plurality of battery cells; and
a second flow plate in contact with the lower cover and disposed between the plurality of battery cells and the lower cover, and provided to cool the plurality of battery cells,
wherein each of the first flow plate and the second flow plate includes a plurality of flow channels extending in the second direction to guide the cooling fluid in the second direction but are arranged in the first direction.
